(19) United States
(12) Patent Application Publication
(10) Pub. No.: US 2005/0067808 A1
(43) Pub. Date: Mar. 31, 2005

(54) BICYCLE ELECTRICAL CONTROL DEVICE WITH A NON-CONTACT RESET FUNCTION

(75) Inventor: Koji Uno, Osaka (JP)

Correspondence Address: DELAND LAW OFFICE, P.O. BOX 69, KLAMATH RIVER, CA, 96050-0069, US

(73) Assignee: SHIMANO, INC., Sakai (JP)

(21) Appl. No.: 10/711,561

(22) Filed: Sep. 24, 2004

(30) Foreign Application Priority Data
Sep. 30, 2003 (JP) 2003-339924

(51) Int. Cl. B62M 1/02

(52) U.S. Cl. 280/260

(57) ABSTRACT

A bicycle electronic control device comprises a computer unit and a reset unit structured to provide a reset signal to the computer component in response to a non-contact operation.

### BACKGROUND OF THE INVENTION

The present invention is directed to bicycles and, more particularly, to a bicycle electronic control device with a non-contact reset function.

In recent years, bicycles have been equipped with electronic control devices that incorporate microcomputer chips or the like powered by a battery. Such electronic control devices include devices for automatically shifting a bicycle transmission based on bicycle speed, devices for controlling a display that displays velocity, trip distance, or the like, and other control devices.

Sometimes, the microcomputer or the like experiences a system error resulting from noise, a program bug, or from some other disturbance. Such a system error can result in the electronic control device entering an unintended routine which, in turn, can cause loss of control of the electronic control device. To alleviate such problems, known electronic control devices are provided with a reset switch that may be pressed to reset the device. Such a device is disclosed in JP 7-37642. The reset switch usually is a contact switch having a movable operating member that is operated with the fingertip. Operating the reset switch sends a reset signal to the reset terminal of the microcomputer.

Since a bicycle usually is ridden or stored outdoors, foreign matter (e.g., solid material such as mud or tar from the road, or liquids such as rain water) tends to become deposited on the bicycle and components attached to it. For example, an electronic control device mounted in the lower portion of the bicycle will be susceptible to being splashed with foreign matter thrown up from the road. While an electronic control device such as a cycle computer mounted on the upper portion of the bicycle may not be subjected to solid material thrown up from the road because of the elevation of the device, it is still susceptible to rain water or other liquids from above or below. When a liquid is deposited on an electronic control device, the liquid may penetrate into the interior and may be deposited on the reset switch operating member. Because of the conductivity of many liquids, the reset switch may experience an insulation fault, thus possibly resulting in a malfunction such as an unintended reset of the microcomputer in the device. Deposited solid matter, on the other hand, can harden and clog up the reset switch operating member, thus making it difficult or impossible to operate the reset switch. To prevent such malfunctions, a waterproof construction must be provided for the reset switch operating member.

### SUMMARY OF THE INVENTION

The present invention is directed to various features of an electronic control device. In one embodiment, a bicycle electronic control device comprises a computer unit and a reset unit structured to provide a reset signal to the computer unit in response to a non-contact operation. Additional inventive features will become apparent from the description below, and such features may be combined with the above features to provide additional benefits.

### BRIEF DESCRIPTION OF THE DRAWINGS

FIG. 1 is a side view of a particular embodiment of a bicycle;

FIG. 2 is a detailed view of components mounted to the handlebar;

FIG. 3 is a schematic block diagram of a particular embodiment of an electronic bicycle shift control device;

FIG. 4 is a detailed view of a particular embodiment of a bicycle rear derailleur;

FIG. 5 is a schematic block diagram of a particular embodiment of relevant control components for the rear derailleur;

FIG. 6 is a side view of an alternative embodiment of a bicycle;

FIG. 7 is a schematic block diagram of another embodiment of an electronic bicycle shift control device; and

FIG. 8 is a schematic block diagram of another embodiment of relevant control components for the rear derailleur.

### DETAILED DESCRIPTION OF THE EMBODIMENTS

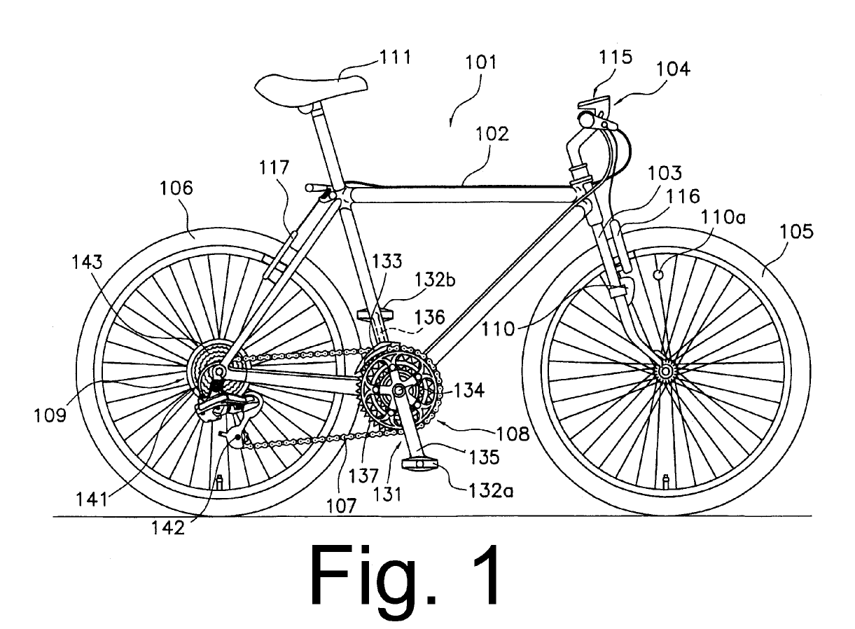

FIG. 1 is a side view of a particular embodiment of a bicycle 101. More specifically, bicycle 101 comprises a frame body 102 and a front fork 103 rotatably mounted to the front of frame body 102 for rotation around an inclined axis. A handlebar 104 is mounted to the top of front fork 103, and a front wheel 105 is rotatably mounted to the bottom of front fork 103. A sensor such as a rotation sensor 110 for sensing a riding condition such as rotation of front wheel 105 is disposed in close proximity to front wheel 105. In this embodiment, rotation sensor 110 comprises a reed switch attached to front fork 103 for providing electrical pulses in response to the passage of a magnet 110a attached to front wheel 105. A rear wheel 106 is rotatably mounted to the rear of frame body 102.

A drive unit is mounted to a lower portion of frame body 102, and a saddle 111 is mounted to an upper portion of frame body 102. Drive unit comprises a front transmission 108, a rear transmission 109, a chain 107 and a shift control device 115 for controlling various components including front transmission 108 and rear transmission 109 in manual and automatic shift modes of operation. Front transmission 108 comprises a front derailleur 133, a crank 131 and a plurality of, e.g., three sprockets 137. Crank 131 is rotatably mounted at the bottom bracket portion of frame body 102 through an axle 134, and it comprises a right crank arm 135 with an attached pedal 132a, and a left crank arm 136 with an attached pedal 132b. Right crank arm 135 also supports the plurality of sprockets 137. Rear transmission 109 comprises a rear derailleur 142 and a sprocket cluster 141 with a plurality of, e.g., nine sprockets 143 mounted for rotation with rear wheel 106. Front derailleur 133 selectively engages chain 107 with one of the plurality of front sprockets 137, and rear derailleur 142 engages chain 107 with one of the plurality of rear sprockets 143, both in response to signals received from shift control device 115.

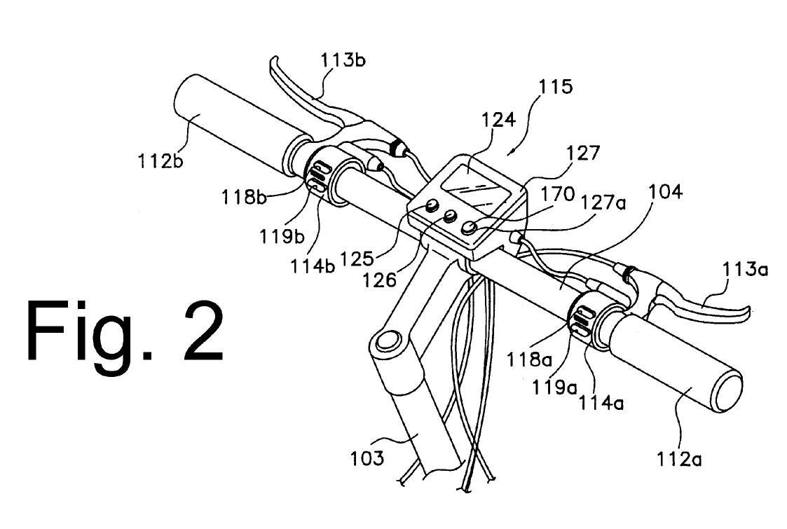

As shown in FIG. 2, a grip 112a and a brake lever 113a are disposed at the right side of handlebar 104, and a grip 112b and a brake lever 113b are disposed at the left side of handlebar 104. Brake lever 113a operates a rear brake 117 (FIG. 1), and brake lever 113b operates a front brake 116. A shift control switching unit 114a having an upshift switch 118a and a downshift switch 119a for operating rear transmission 109 in manual shift mode is disposed at the right side brake lever 113a, and a shift control switching unit 114b having an upshift switch 118b and a downshift switch 119b for operating front transmission 108 in manual shift mode is disposed at the left side brake lever 113b. The upshift switches 118a and 118b each output a command signal for upshifting the corresponding rear transmission 109 and front transmissions 108 by one gear, and the downshift switches 119a and 119b each output a command signal for downshifting the corresponding rear transmission 109 and front transmission 108 by one gear.

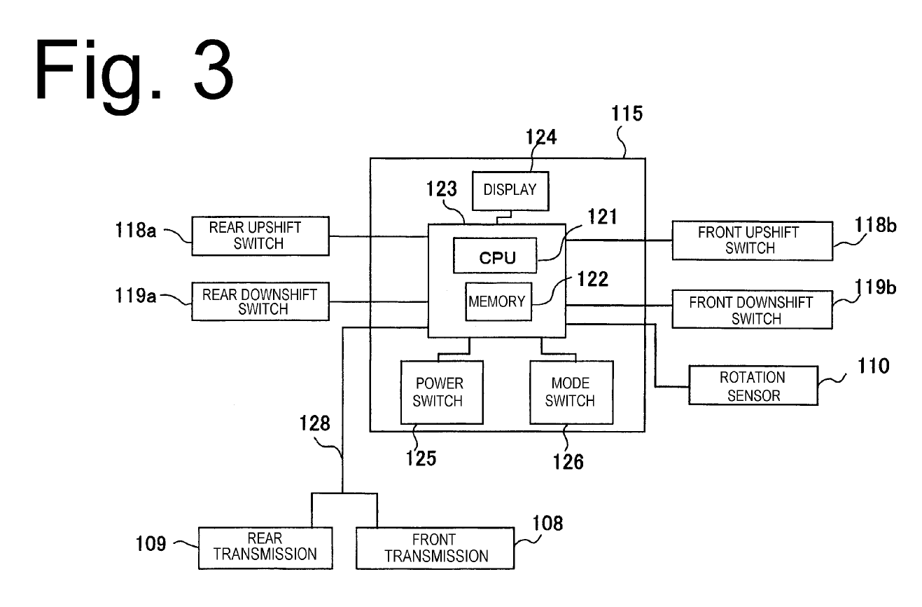

In manual shift mode, shift control device 115 generates shift signals for operating front transmission 108 in response to command signals provided by shift control switching unit 114b and generates shift signals for operating rear transmission 109 in response to command signals provided by shift control switching unit 114a. In automatic shift mode, shift control device 115 generates shift signals for operating front transmission 108 and rear transmission 109 in response to speed signals from rotation sensor 110. As shown in FIG. 3, shift control device 115 comprises a control unit 123 that includes a CPU 121 and a memory 122; a liquid crystal display unit 124 connected to control unit 123 for displaying current bicycle speed, cumulative distance, gear position or other travel information; a power switch 125 connected to control unit 123 for turning display unit 124 on and off; and a mode switch 126 connected to control unit 123 for switching shift control device 115 between manual and automatic shift modes of operation. Thus, shift control device 115 also functions as a conventional cycle computer. Also connected to control unit 123 are rotation sensor 110 and front and rear upshift/downshift switches 118a, 118b, 119a and 119b. Front transmission 108 and rear transmission 109 are connected to control unit 123 through wires 128. As shown in FIG. 2, shift control device 115 is housed within a box-shaped control case 127, with display unit 124, power switch 125 and mode switch 126 disposed on the upper face thereof.

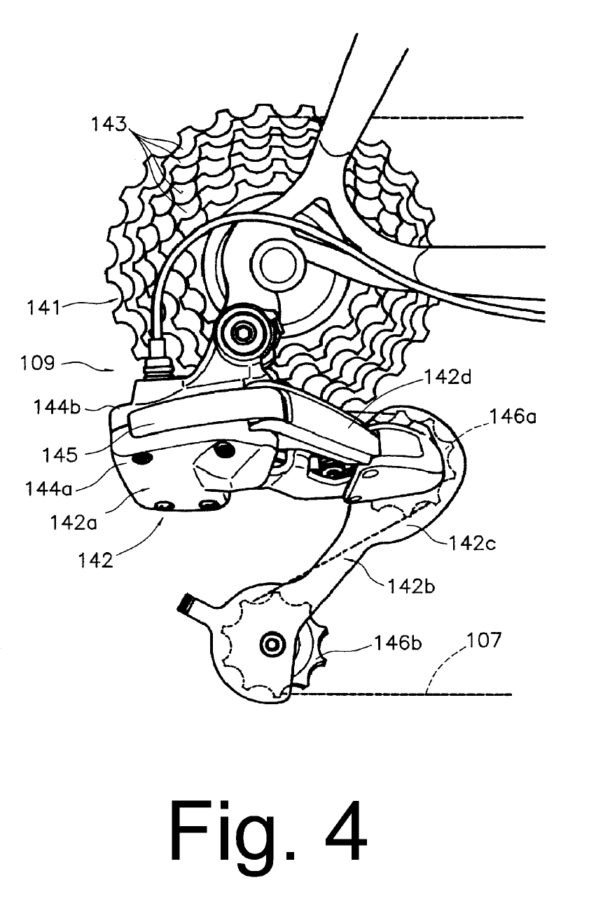

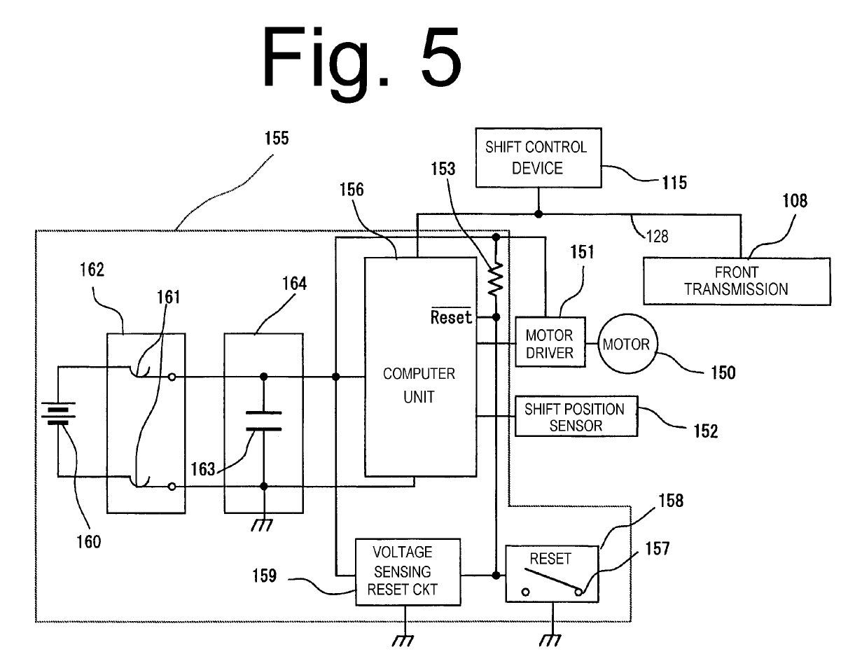

As shown in FIG. 4, rear derailleur 142 comprises a base 142a, a chain guide 142b and a four-point link mechanism 142d that connects base 142a and chain guide 142b together so that chain guide 142b moves laterally relative to base 142a. Chain guide 142b comprises a guide 142c that rotatably supports two spaced-apart pulleys 146a and 146b for supporting chain 107. Base 142a comprises a pair of aluminum alloy mounting members 144a and 144b that sandwich a synthetic resin housing 145. Inside housing 145 is installed a shift motor 150 (FIG. 5) equipped with a typical gear reduction mechanism (not shown). Motor 150 is linked to four-point link mechanism 142d and moves four-point link mechanism 142d so that chain guide 142c moves laterally in a stepwise manner towards or away from rear wheel 106 for guiding chain 107 among the plurality of sprockets 143.

Also mounted within housing 145 is an electronic control device 155 (FIG. 5) for controlling motor 150 in response to shift signals from shift control device 115. As shown in FIG. 5, electronic control device 155 includes a computer unit 156 for controlling motor 150 according to a predetermined program. Computer unit 156 may comprise a one-chip microcomputer that includes, for example, a CPU, RAM, ROM, and I/O interface. Computer unit 156 is connected to shift control device 115 through wires 128, wherein the shift signals output by shift control device 115 function as command inputs to computer unit 156. Electronic control device 155 further comprises a reset unit 158 having a reset switch 157 that outputs a reset signal to a reset terminal of computer unit 156 to reset computer unit 156, a voltage sensing reset circuit 159 for providing a reset signal to the reset terminal of computer unit 156 in the event of a power interruption, a battery 160, a connector unit 162, and a backup unit 164.

Motor 150 is connected to computer unit 156 through a motor driver 151. A shift position sensor 152 that senses the shift position of rear derailleur 142 is connected to computer unit 156 so that computer unit 156 may communicate the shift position to shift control device 115.

Reset switch 157 of reset unit 158 may comprise a reed switch that may be switched on and off by a non-contact operation, such as by being brought into close proximity with a magnet. In this embodiment, reset switch 157 is a normally open (off) contact switch that closes (turns on) when a magnet is brought into close proximity with it. One terminal of reset switch 157 is connected to the reset terminal of computer unit 156, and the other terminal of reset switch 157 is connected to a ground potential. Thus, when a magnet is brought into close proximity with reset switch 157, reset switch 157 closes and provides a Low reset signal to the reset terminal of computer unit 156. Since the pair of mounting members 144a and 144b and the housing 145 of rear derailleur 142 are produced from nonmagnetic material (i.e. aluminum alloy and synthetic resin), they are unaffected by magnetic forces when a reed switch is employed as reset switch 157.

Battery 160 functions as the main power supply for computer unit 156 and motor 150. Connector unit 162 has two connectors 161 so that battery 160 may be detachably connected to connector unit 162. Backup unit 164 has a charge storage element 163 connected in parallel with connector unit 162 and battery 160 for storing power from battery 160. Charge storage element 163 may comprise a large-capacity capacitor with a capacity of about 1000 μF. A voltage of approximately 3V, for example, may be provided to computer unit 156 via charge storage element 163, and this voltage may be maintained even when battery 160 is detached from connector unit 162 in order to replace the battery, or due to vibration or the like. One terminal, e.g., a negative terminal, of backup unit 164 is connected to a ground potential, and another terminal, e.g., a positive terminal, is connected to voltage sensing reset circuit 159, to motor driver 151, and via resistance 153 to the reset terminal of computer unit 156. Thus, the signal at the reset terminal of computer portion 156 is normally Hi as a result of the voltage from charge storage element 163. Voltage sensing reset circuit 159 also is connected to the reset terminal of computer unit 156. Voltage sensing reset circuit 159 senses the voltage of charge storage element 163 and outputs a reset signal to computer unit 156 in the event that the voltage of charge storage element 163 falls below predetermined value (e.g., 1.8 V).

An electronic control device similar to that installed in base unit 142a of rear derailleur 142 is installed in the base unit of front derailleur 133. Since the electronic control device for front derailleur 133 has a similar structure and operation as the electronic control device for rear derailleur 142, a separate description will not be provided.

In operation of rear derailleur 142, once the rider installs a battery as the power supply for shift control device 115 and electronic control device 155, shift control of bicycle 101 is initialized and enabled. In manual shift mode, a shift signal is output by shift control device 115 to the computer unit 156 of electronic control device 155 in response to pushing of rear upshift button 118a and rear downshift button 119a. Computer unit 156 then outputs the appropriate control signals to motor driver 151 to control the motor 150 and shift rear derailleur 142 to engage chain 107 with the appropriate sprocket 143.

In automatic shift mode, shift control device 115 compares an upshift threshold value and a downshift threshold value to a current velocity value calculated from signals output by rotation sensor 110. Shift control device 115 generates a shift signal when the current velocity value passes one of the upshift threshold value and downshift threshold value so that front derailleur 133 and/or rear derailleur 142 engages chain 107 with the appropriate front sprocket 134 and/or rear sprocket 143.

If the computer unit 156 of electronic control device 155 for rear derailleur 142 has malfunctioned because of a system error, a magnet may be brought into proximity with the reset switch 157, thus turning reset switch 157 on to reset computer portion 156. If a magnet were not available, battery 160 may be removed in order to induce reset by the voltage sensing reset circuit 159. Assuming the charge storage element 163 is rated at 1000 μF, power consumption during malfunction is 1 μA, normal operating power supply voltage is 3 V, and reset voltage is 1.8 V, it would take approximately 20 minutes for charge storage element 163 to discharge below the 1.8 V reset voltage. Thus, voltage sensing reset circuit 159 would output a reset signal in approximately 20 minutes. This allows computer portion 156 to be reset if a magnet is not available. At the same time, reset is avoided when it is not desired, such as when changing battery 160 or in the event of transient power fluctuations.

In the present embodiment, since a reed switch or other non-contact switch is used as a reset switch 157, a reset signal can be output immediately by means of a non-contact operation such as by bringing a magnet into proximity with reset switch 157. Since reset switch 157 lacks an operating member, there is no need for waterproof or other conventional protective construction of reset unit 158. It would be difficult for liquids to penetrate inside reset unit 158, and for problems to occur even if liquids did enter reset unit 158. Similarly, since the reset operation takes place by means of a non-contact operation, problems caused by deposited solid matter are not likely to occur.

The magnet used for reset operations may be provided, for example, in the form of a key holder to which is attached the key for a bicycle theft prevention device. Alternatively, such a magnet may be detachably mounted on a component of the bicycle. For example, as shown in FIG. 2, a magnet holder 127a for storing a magnet 170 could be disposed on the control case 127 of shift control device 115. Alternatively, the magnet 110a used as the signal generating device for rotation sensor 110 could be designed to be detachable, thereby allowing the magnet 110a to be used for reset operations.

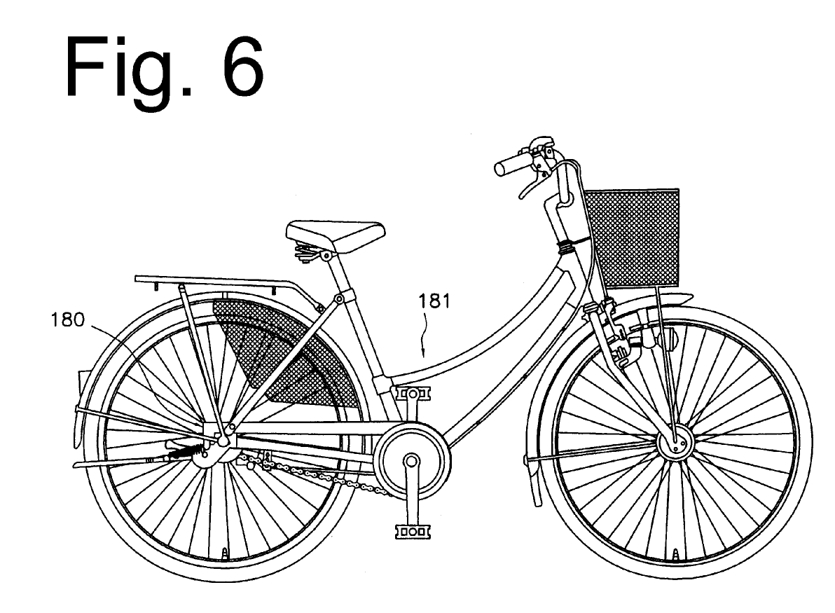

While the above is a description of various embodiments of inventive features, further modifications may be employed without departing from the spirit and scope of the present invention. For example, while the described embodiment involved an electronic control device installed on the derailleur of an external transmission, the teachings herein could be applied to any bicycle electronic control device that benefits from a reset operation. For example, as shown in FIG. 6, the teachings herein could be implemented in an electronic control device installed in an internal hub transmission 180 of a bicycle 181, wherein internal hub transmission 180 is electronically controlled. Since the construction of such a bicycle 181 is known in the art, it will not be further described here.

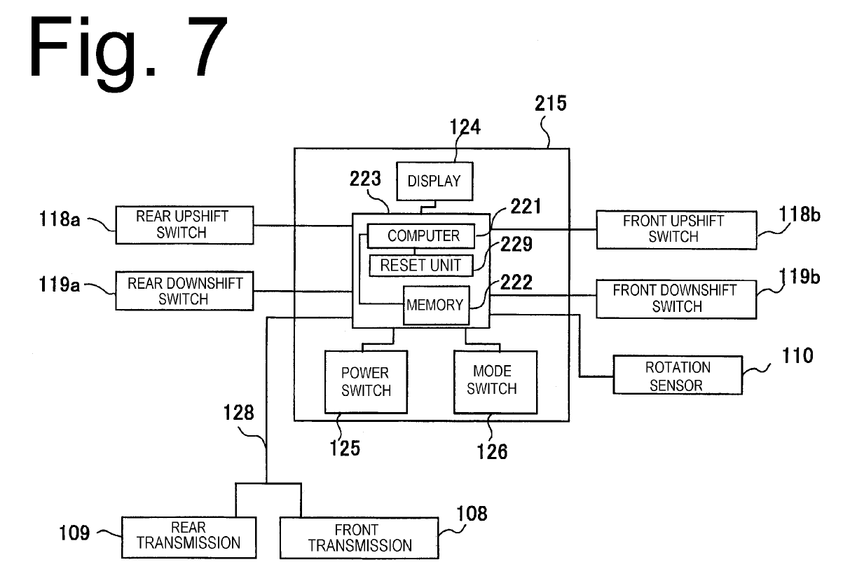

FIG. 7 is a schematic block diagram of another embodiment of an electronic control device. In this embodiment, a control unit 223 of a shift control device 215 may comprise a computer unit 221 that includes a CPU, a reset unit 229, and a memory 222. In this embodiment, electronic control devices are not disposed on the front and rear transmissions 108 and 109. Instead, motors or other control equipment for the front and rear transmissions 108 and 109 may be controlled directly by control unit 223.

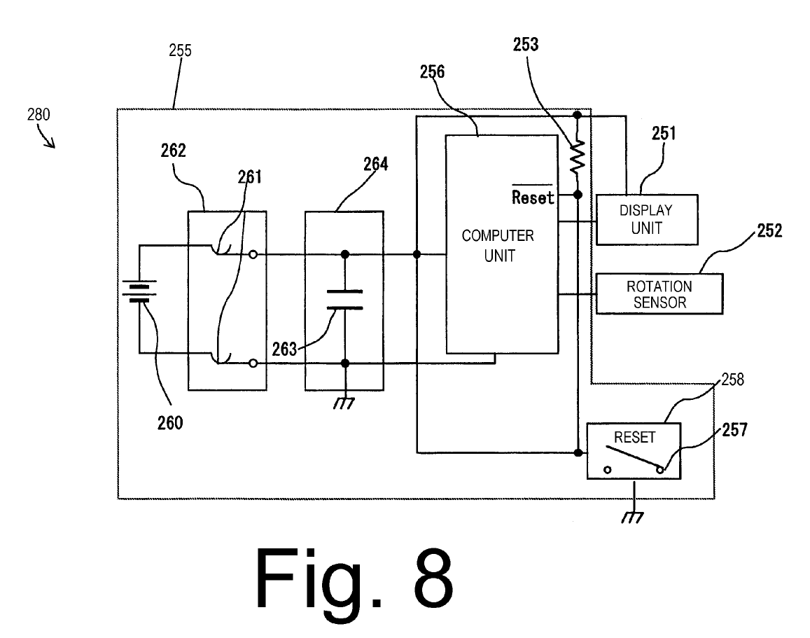

FIG. 8 is a schematic block diagram of another embodiment of an electronic control device. In this embodiment, a cycle computer 280 for calculating and displaying velocity from a wheel rotation sensor 252 could comprise an electronic control device 255 and a display unit 251. Like the electronic control device 155 described previously, electronic control device 255 has a battery 260, a connector unit 262, a backup unit 264, a computer unit 256, and a reset unit 258 with a reset switch 257. The cycle computer 280 has a case member made of nonmagnetic material (synthetic resin, for example). Such an arrangement is unaffected by magnetic force, even if a reed switch is employed as the reset switch.

In the first embodiment described above, a voltage sensing reset circuit 159 was provided, but such a circuit is not required. It is possible to reset computer unit 156 using reset unit 158 only. Also, a reed switch switched on and off by magnetic force was used as the reset switch, but any switch that can be switched on and off by non-contact means, such as an infrared sensor or a photoelectric switch, could be used as well.

The size, shape, location or orientation of the various components may be changed as desired. Components that are shown directly connected or contacting each other may have intermediate structures disposed between them. The functions of one element may be performed by two, and vice versa. The structures and functions of one embodiment may be adopted in another embodiment. It is not necessary for all advantages to be present in a particular embodiment at the same time. Every feature that is unique from the prior art, alone or in combination with other features, also should be considered a separate description of further inventions by the applicant, including the structural and/or functional concepts embodied by such feature(s). Thus, the scope of the invention should not be limited by the specific structures disclosed or the apparent initial focus on a particular structure or feature.

1. A bicycle electronic control device comprising:
a computer unit; and
a reset unit structured to provide a reset signal to the computer unit in response to a non-contact operation.

2. The device according to claim 1 wherein the reset unit comprises a reed switch.

3. The device according to claim 1 wherein the computer unit includes a control signal output that provides a control signal for controlling a bicycle component.

4. The device according to claim 3 wherein the control signal comprises a control signal for controlling a bicycle transmission.

5. The device according to claim 4 wherein the control signal comprises a control signal for controlling an electrically operated derailleur.

6. The device according to claim 4 wherein the control signal comprises a control signal for controlling an electrically operated internal hub transmission.

7. The device according to claim 1 wherein the computer unit includes a command input structured to receive a command for controlling a bicycle component.

8. The device according to claim 7 wherein the command comprises a command for controlling a bicycle transmission.

9. The device according to claim 8 wherein the command comprises a command for controlling an electrically operated derailleur.

10. The device according to claim 8 wherein the command comprises a command for controlling an electrically operated internal hub transmission.

11. The device according to claim 1 further comprising an electrically operated derailleur, wherein at least one of the computer unit and the reset unit are supported by the derailleur.

12. The device according to claim 11 wherein the derailleur comprises a base structured to be mounted to the bicycle and a chain guide coupled to move relative to the base, and wherein the at least one of the computer unit and the reset unit is mounted to the base.

13. The device according to claim 12 wherein the computer unit and the reset unit both are mounted to the base.

14. The device according to claim 1 further comprising an internal hub transmission, wherein at least one of the computer unit and the reset unit are supported by the internal hub transmission.

15. The device according to claim 14 wherein the computer unit and the reset unit both are mounted to the internal hub transmission.

16. The device according to claim 1 wherein the electronic control device comprises a shift control device.

17. The device according to claim 16 wherein the computer unit inputs signals from a manually operated shift control switching unit.

18. The device according to claim 1 further comprising a display that displays travel information.

19. The device according to claim 18 wherein the computer unit, the reset unit and the display unit are housed together in a control case.
